(19) United States
(12) Patent Application Publication
(10) Pub. No.: US 2024/0182695 A1
(43) Pub. Date: Jun. 6, 2024

(54) FLUOROPOLYMER COMPOSITION

(71) Applicant: SOLVAY SPECIALTY POLYMERSITALY S.P.A., Bollate (Milano) (IT)

(72) Inventors: Anne-Charlotte Le Gulluche, Bollate (IT); Marco Colladon, Breda Di Piave (IT); Julio A. Abusleme, Varese (IT)

(73) Assignee: SOLVAY SPECIALTY POLYMERSITALY S.P.A., Bollate (Milano) (IT)

(21) Appl. No.: 18/549,978

(22) PCT Filed: Mar. 3, 2022
(86) PCT No.: PCT/EP2022/055473

§ 371 Date: Sep. 11, 2023

(30) Foreign Application Priority Data
Mar. 10, 2021 (EP) 21161877.2

(51) Int. Cl. C08L 27/16

(52) U.S. Cl. CPC C08L 27/16; C08L 2205/025; C08L 2205/03

(57) ABSTRACT

The present invention relates to a polymeric composition comprising a polymer component A consisting of one or more vinylidene fluoride (VDF) homopolymers in an amount of 90-100% by weight of the polymer component A, and, optionally, of one or more VDF copolymers being present in an amount of 0-10% by weight of the polymer component A, a polymer component B, consisting of one or more (per)fluoropolyethers, in an amount of from 0.05 to 2% by weight based on the weight of polymer component A and a polymer component C, consisting of one or more per(halo)fluoropolymers, in an amount of from 0.1 to 10% by weight based on the weight of polymer component A. The composition is easily processable and have extremely high mechanical properties at elevated temperatures.

### TECHNICAL FIELD

This application claims priority to the European Patent Application N. 21161877.2 filed on 10 Mar. 2021 at the EPO. The whole content of this application being incorporated herein by reference for all purposes.

The invention pertains to thermoplastic fluoropolymer compositions based on vinylidene fluoride (1,1 difluoro ethylene, indicated in the present application as “VDF”), to a process for manufacturing said thermoplastic fluoropolymer compositions and to articles comprising the fluoropolymer composition of the invention.

The compositions of the invention have a high mechanical resistance especially at high temperature, and, at the same time, can be molded and extruded to form articles which are free from surface marks or cracks.

### BACKGROUND ART

Fluorocarbon resins, in particular vinylidene fluoride resins, are endowed with outstanding mechanical properties within a broad range of temperature, good resistance to high temperature, organic solvents and to various chemically aggressive environments. Thanks to their properties they are commonly used for manufacturing articles by extrusion or injection molding, e.g. for producing pipes, tubes, fittings, films, coatings, cable sheathings, flexible pipes and the like.

To further improve the mechanical properties of these polymers, it is well known to increase their molecular weight. This enables using these materials in highly demanding applications, such as, for instance, off shore piping, which requires outstanding performances in terms of impact resistance, high deformability (for unreeling-reeling), high thermal resistance. Thus, although fluoropolymers of high molar mass (and thus high melt viscosity) are preferable because of improved mechanical properties, processing these materials in a molten state is more difficult. In particular, in extrusion and molding processes, they display rheology problems, accounting for increased energy consumption during extrusion and more severe extrusion conditions to be applied (with consequent risks of thermal degradation of the polymer). As known to a skilled person, a higher molecular weight polymer will have in general a higher viscosity in the molten state. When generating a finished parts (via extrusion or injection molding) from such high viscosity melt surface defects like cracks, shark-skin, fish-eyes and the like can be formed.

This invention thus aims at providing a fluoropolymer composition which combines a relatively low viscosity of the melt (thus yielding finished parts with high mechanical properties outstanding surface aspect) with an extremely high mechanical resistance especially at high temperatures.

WO2007006645A1 and WO2007006646A1 from Solvay Specialty Polymers describe polymeric composition comprising a mixture of VDF based homo and copolymers wherein the copolymer is at least 25% in combination with processing additive including (per)fluoropolyethers and per(halo)fluoropolymers. The compositions described in these documents have good mechanical properties and can be easily processed so to obtain finished parts free from structural and surface defects.

However, nowadays there is a demand for materials which, while maintaining the desirable properties of the materials cited above, are also endowed with further improved mechanical properties at high temperatures, e.g. temperature higher than 130° C.

### SUMMARY OF INVENTION

The invention pertains to a thermoplastic polymeric composition comprising:
a) a vinylidene fluoride (VDF) based polymer component A,
b) a polymer component B, consisting of one or more (per)fluoropolyethers, in an amount of from 0.05 to 2% by weight based on the weight of polymer component A,
c) a polymer component t C, consisting of one or more per(halo)fluoropolymers, in an amount of from 0.1 to 10% by weight based on the weight of polymer component A,
the composition being characterized in that said polymer component A consists of one or more vinylidene fluoride (VDF) homopolymers in an amount of 90-100% by weight of the polymer component A, and, optionally, of one or more VDF copolymers being present in an amount of 0-10% by weight of the polymer component A, said one or more VDF copolymers, when present, comprising 80-99% in moles of recurring units derived from VDF and 1-20% in moles of recurring units derived from a comonomer different from VDF.

### DETAILED DESCRIPTION OF THE INVENTION

As mentioned above, the present invention relates to a thermoplastic polymeric composition comprising three polymer components: A, B and C.

Polymer component A is a VDF based polymer component which consists of one or more VDF homopolymers in an amount of from 90 to 100%, preferably from 95 to 100% by weight based on the total weight of polymer component A, and, optionally of one or more VDF copolymers in an amount of 0-10%, preferably 0-5% by weight based on the total weight of polymer component A, wherein the optional one or more VDF copolymers, if present, comprise 80-99% in moles of recurring units derived from VDF and 1-20% in moles of recurring units derived from a comonomer different from VDF.

In other words, polymer component A can consist either of one or more VDF homopolymers or of a mixture of one or more VDF homopolymers and one or more VDF copolymers, the VDF copolymers being defined as above, wherein the VDF copolymers represent 10% or less, preferably 5% or less, by weight based on the total weight of polymer component A.

The term VDF “homopolymer” indicates a polymer wherein essentially all recurring units derive from VDF. As understood by a skilled person, a VDF homopolymer may still comprise a very small amount of recurring units different from VDF. Said recurring units different from VDF may derive from monomer impurities, or be chain ends deriving from the radical initiators used during polymerization or from chain transfer agents, without these substantially affecting the properties of the polymer. For the purposes of the present invention a VDF polymer is defined as a VDF homopolymer if it comprises less than 1% mol of recurring units which are different from VDF.

For the present invention it is preferred that polymer component A only consists of one or more VDF homopolymers, however, as mentioned above polymer component A may also comprise up to 10%, preferably up to 5%, by weight, based on the total weight of the polymer component A, of one or more VDF copolymers.

VDF copolymers suitable for the present invention comprise 80-99% in moles of recurring units derived from VDF and 1-20% in moles of recurring units derived from one or more comonomers different from VDF.

The choice of comonomers for the VDF copolymer in the present invention is not particularly limited and any hydrogenated, partially fluorinated or fully fluorinated comonomers can be used.

Preferably the comonomers different from VDF are selected among fluorinated comonomers and more preferably among vinylfluoride (VF1), chlorotrifluoroethylene (CTFE), hexafluoropropene (HFP), tetrafluoroethylene (TFE), trifluoroethylene (TrFE), (per)fluoroalkylvinylethers (among these perfluoromethylvinylether of formula CF2═CFO—CF₃ is preferred), perfluoroalkylethylenes (among these perfluorobutylethylene is preferred), (per)fluorodioxoles as described in U.S. Pat. No. 5,597,880, or mixtures thereof.

The melt flow index (MFI) of the polymer component A is preferably selected to be less than 20, preferably less than 10, more preferably less than 8 g/10 min, even more preferably less than 7 g/10 min, most preferably less than 5 g/10 min, and at least 0.01, preferably at least 0.05, more preferably at least 0.1 g/10 min. (when measured according to ASTM D-1238 standard under a piston load of 21.6 kg at 230° C.

Polymer component B consists of one or more (per)fluoropolyethers. Within the context of the present invention, the term (per)fluoropolyether is intended to denote a polymer comprising recurring units (R1), said recurring units comprising at least one ether linkage in the main chain and at least one fluorine atom (fluoropolyoxyalkene chain).

Preferably the recurring units R1 of the (per)fluoropolyether are selected from the group consisting of :
(I) —CFX—O—, wherein X is —F or —CF₃;
(II) —CF₂—CFX—O—, wherein X is —F or —CF₃;
(III) —CF₂—CF₂—CF₂—O—;
(IV) —CF₂—CF₂—CF₂—CF₂—O—;
(V) —(CF₂)ⱼ—CFZ—O— wherein j is an integer chosen from 0 and 1 and Z is a fluoropolyoxyalkene chain comprising from 1 to 10 recurring units chosen among the classes (I) to (IV) here above;
and mixtures thereof.

Should the (per)fluoropolyether comprise recurring units R1 of different types, advantageously said recurring units are randomly distributed along the fluoropolyoxyalkene chain.

Preferably the (per)fluoropolyether polymer component B comprises and preferably consists of compounds complying with formula (I) here below:

T₁—(CFX)ₚ—O—R_{f}—(CFX)_{p′}—T₂ (I)

wherein:
each of X is independently F or CF₃;
p and p′, equal or different each other, are integers from 0 to 3;
R_{f} is a fluoropolyoxyalkene chain comprising repeating units being chosen among the group consisting of:
   (i) —CFXO—, wherein X is F or CF₃,
   (ii) —CF₂CFXO—, wherein X is F or CF₃,
   (iii) —CF₂CF₂CF₂O—,
   (iv) —CF₂CF₂CF₂CF₂O—,
   (v) —(CF₂)ⱼ—CFZ—O— wherein j is an integer chosen from 0 and 1 and Z is a group of general formula —OR_{f}′T₃, wherein
      R_{f}′ is a fluoropolyoxyalkene chain comprising a number of repeating units from 0 to 10, said repeating units being chosen among the following:
      —CFXO—, —CF₂CFXO—, —CF₂CF₂CF₂O—, —CF₂CF₂CF₂CF₂O—, with each X being independently F or CF₃; and T₃ being a C₁-C₃ perfluoroalkyl group, and mixtures thereof;
T₁ and T₂, are independently selected from
   i) H,
   ii) halogen atoms,
   iii) C₁-C₃₀ end-group optionally comprising heteroatoms chosen among O, S, N and/or halogen atoms.

Preferably, T₁ and T₂ are selected from the group consisting of:
(j) —Y′, wherein Y′ is chain end chosen among —H, halogen, such as —F, —Cl, C₁-C₃ perhalogenated alkyl group, such as —CF₃, —C₂F₅, —CF₂Cl, —CF₂CF₂Cl;
(jj) —Eᵣ—A_{q}—Y″ₖ, wherein k, r and q are integers, with q=0 or 1, r=0 or 1, and k between 1 and 4, preferably between 1 and 2, E denotes a functional linking group comprising at least one heteroatom chosen among O, S, N; A denotes a C₁-C₂₀ bivalent linking group; and Y″ denotes a functional end-group.

The functional group E may comprise an amide, ester, carboxylic, thiocarboxylic, ether, heteroaromatic, sulfide, amine, and/or imine group.

Non limitative examples of functional linking groups E are notably —CONR— (R═H, C₁-C₁₅ substituted or unsubstituted linear or cyclic aliphatic group, C₁-C₁₅ substituted or unsubstituted aromatic group); —COO—; —COS—; —CO—; an heteroatom such as —O—; —S—; —NR′—(R═H, C₁-C₁₅ substituted or unsubstituted linear or cyclic aliphatic group, C₁-C₁₅ substituted or unsubstituted aromatic group); a 5- or 6-membered aromatic heterocycle containing one or more heteroatoms chosen among N, O, S, the same or different each other, in particular triazines, such as

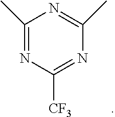

The bivalent C₁-C₂₀ linking group A is preferably selected from the following classes:
1) linear substituted or unsubstituted C₁-C₂₀ alkylenic chain, optionally containing heteroatoms in the alkylenic chain; preferably linear aliphatic group comprising moieties of formula —(CH₂)ₘ—, with m integer between 1 and 20, and optionally comprising amide, ester, ether, sulfide, imine groups and mixtures thereof;
2) (alkylene)cycloaliphatic C₁-C₂₀ groups or (alkylen)aromatic C₁-C₂₀ groups, optionally containing heteroatoms in the alkylenic chain or in the ring, and optionally comprising amide, ester, ether, sulfide, imine groups and mixtures thereof;
3) linear or branched polyalkylenoxy chains, comprising in particular repeating units selected from : —CH₂CH₂O—, —CH₂CH(CH₃)O—, —(CH₂)₃O—, —(CH₂)₄O—, optionally comprising amide, ester, ether, sulfide, imine groups and mixtures thereof.

Examples of suitable functional groups Y″ are notably —OH , —SH, —OR′, —SR′, —NH₂, —NHR′, —NR′₂, —COOH, —SiR′_{d}Q_{3-d}, —CN, —NCO,

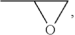

1,2- and 1,3-diols as such or as cyclic acetals and ketals (e.g., dioxolanes or dioxanes), —COR′, —CH(OCH₃)₂, —CH(OH)CH₂OH, —CH(COOH)₂, —CH(COOR′)₂, —CH(CH₂OH)₂, —CH(CH₂NH₂)₂, —PO(OH)₂, —CH(CN)₂, wherein R′ is an alkyl, cycloaliphatic or aromatic substituted or unsubstituted group, optionally comprising one or more fluorine atoms, Q is OR′, R′ having the same meaning as above defined, d is an integer between 0 and 3.

One or more functional end-groups Y″ can be linked to the group A and/or E: for instance, when A is an (alkylen)aromatic C₁-C₂₀ group, it is possible that two or more Y″ groups are linked to the aromatic ring of the group A.

More preferably, the (per)fluoropolyether of the invention complies with formula (I) here above, wherein the T₁ and T₂ are selected from the group consisting of : —H; halogen such as —F and —Cl; C₁-C₃ perhalogenated alkyl group, such as —CF₃, —C₂F₅, —CF₂Cl, —CF₂CF₂Cl; —CH₂OH; —CH₂(OCH₂CH₂)ₙOH (n being an integer between 1 and 3); —C(O)OH; —C(O)OCH₃; —CONH—R_{H}—OSi(OC₂H₅)₃ (where R_{H} is a C₁-C₁₀ alkyl group); —CONHC₁₈H₃₇; —CH₂OCH₂CH(OH)CH₂OH; —CH₂O(CH₂CH₂O)_{n*}PO(OH)₂ (with n* between 1 and 3);
and mixtures thereof.

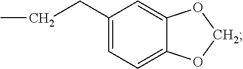

Most preferably, the (per)fluoropolyether polymer component B comprises and preferably consists of compounds chosen among the group consisting of:
(a) HO—CH₂CF₂O(CF₂O)_{n′}(CF₂CF₂O)_{m′}CF₂CH₂—OH, m′ and n′ being integers, where the ratio m′/n′ generally between 0.1 and 10, preferably between 0.2 and 5;
(b) HO(CH₂CH₂O)ₙCH₂CF₂O(CF₂O)_{n′}(CF₂CF₂O)_{m′}CF₂CH₂(OCH₂CH₂)ₙOH, m′ and n′ being integers, where the ratio m′/n′ ranges between 0.1 and 10, preferably between 0.2 and 5, and n ranges between 1 and 3;
(c) HCF₂O(CF₂O)_{n′}(CF₂CF₂O)_{m′}CF₂H, m′ and n′ being integers, where the ratio m′/n′ ranges between 0.1 and 10, preferably between 0.2 and 5;
(d) FCF₂O(CF₂O)_{n′}(CF₂CF₂O)_{m′}CF₂F, m′ and n′ being integers, where the ratio m′/n′ ranges between 0.1 and 10, preferably between 0.2 and 5.

According to a preferred embodiment of the invention, the thermoplastic fluoropolymer compositions comprises a (per)fluoropolyether chosen among types (a) and (b) here above. The presence of terminal hydroxyl groups has been found to be particularly beneficial for the processability of the compositions of the invention.

The weight average molecular mass of the (per)fluoropolyether is preferably comprised between 400, and 100000, more preferably between 600 and 20000.

The (per)fluoropolyethers of the invention can be notably manufactured by photoinitiated oxidative polymerization (photooxidation reaction) of per(halo)fluoromonomers, as described in U.S. Pat. No. 3,665,041. Typically, (per)fluoropolyethers structures can be obtained by combination of hexafluoropropylene and/or tetrafluoroethylene with oxygen at low temperatures, in general below −40° C., under U.V. irradiation, at a wavelength of less than 3 000 Å. Subsequent conversion of end-groups as described in U.S. Pat Nos. 3,847,978 and 3,810,874 is notably carried out on crude products from photooxidation reaction.

The (per)fluoropolyethers of types (a), (b), (c), and (d) as above described, are notably available from Solvay Solexis S.p.A. as FOMBLIN® ZDOL, FOMBLIN® ZDOL TX, H-GALDEN® and FOMBLIN® Z or FOMBLIN® M.

The amount of polymer component B in the thermoplastic polymeric composition of the invention is from 0.05% to 2%, preferably from 0.06% to 1.5%, more preferably from 0.07% to 1%, most preferably from 0.1% to 0.8% by weight, based on the weight of polymer component A.

Polymer component C consists of one or more per(halo)fluoropolymer. For the purpose of the invention, the term “per(halo)fluoropolymer” is intended to denote a fluoropolymer substantially free of hydrogen atoms. The per(halo)fluoropolymer can further comprise one or more other halogen atoms (Cl, Br, I).

The term “substantially free of hydrogen atom” is understood to mean that the per(halo)fluoropolymer is prepared from ethylenically unsaturated monomers comprising at least one fluorine atom and free of hydrogen atoms (per(halo)fluoromonomers). As understood by a skilled person, a per(halo)fluoropolymer may still comprise a very small amount of recurring units containing hydrogen atoms which may derive from monomer impurities, or be chain ends deriving from the radical initiators used during polymerization or from chain transfer agents, without these substantially affecting the properties of the polymer.

The per(halo)fluoropolymer can be a homopolymer of a per(halo)fluoromonomer or a copolymer comprising recurring units derived from more than one per(halo)fluoromonomers.

Non limitative examples of suitable per(halo)fluoromonomers are notably:
C₂-C₈ perfluoroolefins, such as tetrafluoroethylene and hexafluoropropene;
chloro- and/or bromo- and/or iodo- C₂-C₆ fluoroolefins, like chlorotrifluoroethylene;
per(halo)fluoroalkylvinylethers complying with general formula CF₂═CFOR_{f3} in which R_{f3} is a C₁-C₆ per(halo)fluoroalkyl, such as —CF₃, —C₂F₅, —C₃F₇;
CF₂═CFOX₀₁ per(halo)fluoro-oxyalkylvinylethers, in which X₀₁ is a C₁-C₁₂ per(halo)fluorooxyalkyl having one or more ether groups, like perfluoro-2-propoxy-propyl group;
Per(halo)fluoroalkylvinylethers complying with general formula CF₂═CFOCF₂OR_{f4} in which R_{f4} is a C₁-C₆ or per(halo)fluoroalkyl, such as —CF₃, —C₂F₅, —C₃F₇ or a C₁-C₆ per(halo)fluorooxyalkyl having one or more ether groups, —C₂F₅—O—CF₃;
functional per(halo)fluoro-oxyalkylvinylethers complying with formula CF₂═CFOY₀₁, in which Y₀₁ is a C₁-C₁₂ per(halo)fluoroalkyl, or a C₁-C₁₂ per(halo)fluorooxyalkyl having one or more ether groups, and Y₀₁ comprises a carboxylic or sulfonic acid group, in its acid, acid halide or salt form;
per(halo)fluorodioxoles.

Suitable examples of per(halo)fluoropolymers useful in the composition according to the invention are notably TFE copolymers and CTFE copolymers.

Preferred per(halo)fluoropolymers are notably TFE copolymers.

In a preferred embodiment, said polymer component C comprises and preferably consists of one or more per(halo)fluoropolymer selected from TFE copolymers comprising at least 2% wt, preferably at least 7% wt, and at most 30% wt, preferably at most 20% wt, more preferably at most 13% wt of recurring units derived from at least one fluorinated comonomer chosen among the group consisting of :
(i)perfluoroalkylvinylethers complying with formula CF₂═CFOR_{f1′}, in which R_{f1′} is a C₁-C₆ perfluoroalkyl, e.g. CF₃, C₂F₅, C₃F₇; and/or
(ii) perfluoro-oxyalkylvinylethers complying with formula CF₂═CFOX₀, in which X₀ is a C₁-C₁₂ perfluorooxyalkyl having one or more ether groups, like perfluoro-2-propoxy-propyl; and/or
(iii) C₃-C₈ perfluoroolefins, such as hexafluoropropylene.

Suitable TFE copolymers are for example TFE/PAVE polymers. These polymers are known in the industry as PFA and MFA polymers and are commercialized for example by Solvay Specialty Polymers under the brand name Hyflon®. Such polymers can be manufactured using the known polymerization techniques described in the literature. Reference is made for example to European Patent EP633274B1 and PCT application WO2016096961, both from Solvay Specialty Polymers.

In general polymers for use in the present invention as polymer components C can be prepared in aqueous polymerization medium, using emulsion and/or suspension polymerization techniques in a pressurized reactor, feeding the monomers in such reactor and initiating the polymerization using a radical initiator. Surfactants such as fluorinated surfactants and/or non fluorinated surfactants may be used during polymerization to help stabilize the emulsion. Conventional chain transfer agents may also be used to control molecular weight and viscosity of the polymers.

Typically the preparation of polymers suitable for the present invention occurs in emulsion and the resulting material is a polymer finely dispersed in an aqueous medium in the form of a latex. For subsequent processing the polymer is extracted from the latex using known techniques (such as e.g. coagulation by freezing). The extracted polymer is washed with demineralized water and dried at high temperature (e.g. 150.160° C.) to remove residual humidity.

Good results have been obtained with TFE copolymers wherein the fluorinated comonomer is a C₃-C₈ perfluoroolefin and/or a perfluoroalkylvinylether as above specified; particularly good results have been achieved with TFE copolymers wherein the fluorinated comonomer is hexafluoropropylene and/or perfluoromethylvinylether (PMVE) (of formula CF₂═CFOCF₃).

When the per(halo)fluoropolymer is a TFE copolymer wherein the fluorinated comonomer is a perfluoroalkylvinylether as above specified, said TFE copolymer has a dynamic viscosity at a shear rate of 1 s⁻¹ of advantageously at most 100 Pa×sec, preferably of at most 50 Pa×sec, more preferably of at most 30 Pa×sec, most preferably of at most 10 Pa×sec at a temperature of 280° C.

Dynamic viscosity is typically measured with a controlled strain rheometer, employing an actuator to apply a deforming strain to the sample and a separate transducer to measure the resultant stress developed within the sample, using the parallel plate fixture.

According to an embodiment of the invention, the per(halo)fluoropolymers of the invention are selected from a tetrafluoroethylene/perfluoromethylvinylether (TFE/PMVE) copolymer consisting essentially of:
from 4 to 25% moles, preferably from 5 to 20% wt, most preferably from 10 to 16% moles of recurring units derived from PMVE; and
from 96 to 75% moles, preferably from 95 to 80, most preferably from 90 to 84% moles of recurring units derived from TFE.

Preferably the polymer component C is melt-processable.

For the purposes of the present invention, by the term “melt-processable” is meant that the polymer component C can be processed (i.e. fabricated into shaped articles such as films, fibers, tubes, wire coatings and the like) by conventional melt extruding, injecting or casting means. Such typically requires that the dynamic viscosity at a shear rate of 1 s⁻¹ and at a temperature exceeding melting point of roughly 30° C., preferably at a temperature of Tₘ₂+(30±2° C.), is of less than 10⁶ Pa×s, when measured with a controlled strain rheometer, employing an actuator to apply a deforming strain to the sample and a separate transducer to measure the resultant stress developed within the sample, and using the parallel plate fixture.

The melting point (as Tₘ₂) is determined by DSC, at a heating rate of 10° C./min, according to ASTM D 3418.

When polymer component C is melt processable, it has a dynamic viscosity at a shear rate of 1 s⁻¹ in the above specified conditions preferably of less than 2 000 Pa×s, more preferably of less than 700 Pa×s.

Should the polymer component C be melt-processable, the ratio between the melt flow index of the polymer component C and the melt flow index of the polymer component A is advantageously at least 5, preferably at least 10, more preferably at least 20.

The melt flow index of polymer component C is measured in accordance with ASTM test No. 1238.

The amount of polymer component C in the thermoplastic polymeric composition of the invention is from 0.1% to 10%, preferably from 0.2% to 8%, more preferably from 0.3% to 5%, most preferably from 0.5% to 4% by weight of the polymer component A.

End chains, impurities, defects and minor amount of other comonomers may be present in polymer components A, B and C, without these substantially affecting the properties of the polymer component.

The composition of the invention may optionally comprise a plasticizer. Plasticizers suitable for the composition of the invention may be chosen from the usual monomeric or polymeric plasticizers for fluoropolymers.

Plasticizers described in U.S. Pat. No. 3,541,039 (PENNWALT CORP) and those described in U.S. Pat. No. 4,584,215 (INST FRANCAIS DU PETROL) are suitable for the compositions of the invention.

The plasticizers are incorporated without any difficulty in the compositions of the invention defined above and produce compositions whose impact strength, especially at low temperature, is advantageously improved. In other words, plasticizers can be advantageously used in the compositions of the invention to improve the low temperature behaviour of final parts made from inventive compositions, especially when these parts are submitted to extreme operating temperatures.

Among monomeric plasticizers, mention can be notably made of dibutyl sebacate (DBS), N-n-butylsulphonamide, acetyl-tri-n-butylcitrate of formula

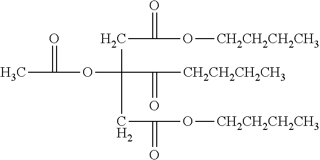

and dibutoxyethyladipate of formula:

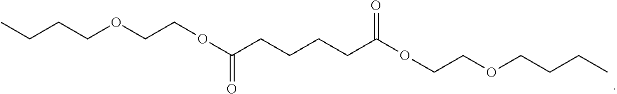 [SMILES: CCCCOCCOC(=O)CCCCC(=O)OCCOCCCC]

A plasticizer which has shown itself to be particularly advantageous within the context of the present invention is DBS:

(C₄H₉—OOC—(CH₂)₈—COO—C₄H₉).

Among polymeric plasticizers, mention can be notably made of polymeric polyesters such as those derived from adipic, azelaic or sebacic acids and diols, and their mixtures, but on condition that their molecular mass is at least approximately 1500, preferably at least 1800, and not exceeding approximately 5000, preferably lower than 2500. Polyesters of excessively high molecular mass result, in fact, in compositions of lower impact strength.

Should the composition of the invention comprise a plasticizer, the amount of plasticizer is preferably of between 1% and 20%, more preferably between 2% and 10%, by weight of the polymer component A.

Optionally, the composition described above can further comprise pigments, filling materials, electrically conductive particles, lubricating agents, mold release agents, heat stabilizer, anti-static agents, extenders, reinforcing agents, organic and/or inorganic pigments like TiO₂, carbon black, acid scavengers, such as MgO, flame-retardants, smoke-suppressing agents and the like.

By way of non-limiting examples of filling material, mention may be made of mica, alumina, talc, carbon black, glass fibers, carbon fibers, graphite in the form of fibers or of powder, carbonates such as calcium carbonate, macromolecular compounds and the like.

Pigments useful in the composition notably include, or will comprise, one or more of the following: titanium dioxide which is available form Whittaker, Clark & Daniels, South Plainfield, New Jersey, USA; Artic blue #3, Topaz blue #9, Olympic blue #190, Kingfisher blue #211, Ensign blue #214, Russet brown #24, Walnut brown #10, Golden brown #19, Chocolate brown #20, Ironstone brown #39, Honey yellow #29, Sherwood green #5, and Jet black #1 available from Shepard Color Company, Cincinnati, Ohio, USA.; black F-2302, blue V-5200, turquoise F-5686, green F-5687, brown F-6109, buff F-6115, chestnut brown V-9186, and yellow V-9404 available from Ferro Corp., Cleveland, Ohio, USA and METEOR® pigments available from Englehard Industries, Edison, New Jersey, USA.

It is preferred that the total amount of the polymer components A, B and C makes up at least 80%, more preferably at least 90%, even more preferably at least 95 by weight of total amount of polymers contained in the thermoplastic composition of the present invention.

Another aspect of the present invention concerns a process for manufacturing the thermoplastic fluoropolymer composition of the invention described above, said process comprising mixing polymer components A, B and C, optionally with one or more plasticizers and/or other optional ingredients.

Melt compounding can be conducted in continuous or batch devices. Such devices are well-known to those skilled in the art.

Examples of suitable continuous devices to melt compound the thermoplastic fluoropolymer composition of the invention are notably screw extruders. In this case the polymer components A, B and C and other optional ingredients, are fed in an extruder and the thermoplastic fluoropolymer composition is extruded. Preferably the extruded is a twin screw extruder. Examples of suitable extruders well-adapted to the process of the invention are those available from Werner and Pfleiderer and from Farrel.

This operating method can be applied also with a view to manufacturing finished product such as, for instance, hollow bodies, pipes, laminates, calendared articles, or with a view to having available granules containing the desired composition, optionally additives and fillers, in suitable proportions in the form of pellets, which facilitates a subsequent conversion into finished articles. With this latter aim, the thermoplastic fluoropolymer composition of the invention is advantageously extruded into strands and the strands are chopped into pellets.

The thermoplastic fluoropolymer composition of the invention can be processed following standard methods for injection molding, extrusion, thermoforming, machining, and blow molding.

Still an object of the invention is an article comprising the thermoplastic fluoropolymer composition as above described or obtainable by the process as above described.

Advantageously the article is an injection molded article, an extrusion molded article, a machined article, a coated article or a casted article.

Non-limitative examples of articles are coatings, films, membranes, shaped films, cable sheathing, pipes, flexible pipes, hollow bodies, fittings, housings.

Preferably the article is a pipe. Pipes according to the invention advantageously comprise at least one layer comprising the thermoplastic fluoropolymer composition.

Articles of the invention can advantageously find application in the oil and gas industry. Articles for oil field applications include shock tubing, encapsulated injection tubing, coated rod, coated control cables, down-hole cables, flexible flow lines and risers.

A particular example of articles of the invention is provided by reinforced flexible pipes, notably used in the oil industry for the transport of recovered fluids between installations at an oil field, and for the transport of process liquids between an installation positioned at the surface of the sea and an installation positioned below the surface of the sea. The reinforced flexible pipe of the invention typically comprises at least one layer comprising, preferably consisting essentially of the composition of the invention. It is also understood that the reinforced flexible pipe of the invention may comprise one or more than one layer comprising (preferably consisting essentially of) the composition of the invention.

A common type of the above-mentioned reinforced flexible pipes has generally a tight inner barrier layer comprising the composition of the invention, on whose inner side a collapse resistant layer, frequently called a carcass, is arranged, the purpose of which is to prevent the inner barrier layer from collapsing because of external pressure impacts.

One or more load-carrying reinforcement layers are arranged externally on the inner collapse resistant layer and the inner liner. These load-carrying reinforcement layers are sometimes also referred to as pressure reinforcement layers, tension reinforcement layers or cross reinforcement layers. These layers will be called hereinafter “the outer reinforcement layer”. Generally, the outer reinforcement layer is composed of two layers arranged on top of each other, where the layer closest to the inner liner is of a nature such that it absorbs radial forces in the pipe (pressure reinforcement layer), while the overlying reinforcement layer primarily absorbs axial forces in the pipe (tension reinforcement layer). Finally, the outer reinforcement layer may have arranged externally thereon a tight jacket or external fluid barrier, which avoid the outer reinforcement layer to be freely exposed to the surroundings and which assure thermal insulation. Also, said external fluid barrier may comprise the composition of the invention.

Articles of the invention are also particularly suitable for the CPI market (Chemical Process Industry), wherein, typically
corrosion-resistant linings comprising the composition of the invention can be applied by powder coating, sheet lining, extruded lining, rotational lining or other standard technique;
membranes comprising the composition of the invention can be made with varying degrees of porosity and manufacturing methods for use in water purification, foodstuffs dehydration, filtration of chemicals, and the like;
pipes, valves, pumps and fittings comprising the composition as above described can be used in chemical process equipment when excellent temperature and chemical resistance are required. Small pieces can economically be made entirely of the composition of the invention. Extruded or molded components include tubes, pipes, hose, column packing, pumps, valves, fittings, gaskets, and expansion joints.

Also, articles of the invention are advantageously suitable for building and architecture applications; in this domain, typically:
flexible corrugated ducts comprising the composition of the invention advantageously prevent corrosion from SO2 and other products of combustion in residential chimney flues;
pipes and fittings comprising the composition of the invention advantageously provide for long life hot water service.

Moreover, articles of the invention can advantageously find application in the semiconductors industry, where the composition of the invention can, for instance, act as strong, tough, high purity material used routinely as structural materials in wet bench and wafer processing equipment. In the same field the composition of the invention is also suitable for construction of fire-safe wet benches.

The specific combination of components in the composition of the invention combining a VDF polymer base which is rich in selected VDF homopolymer together with the addition of small amounts of selected (per)fluoropolyethers and per(halo)fluoropolymers acting as processing aids, allows to obtain a polymeric materials which has outstanding mechanical properties especially at elevated temperatures such as 150° C., combined with an excellent rheological behavior making possible processing the composition in mild temperature conditions and yielding final parts with outstanding surface aspect and good homogeneity and coherency which are free of cracks or marks or surface imperfections.

The outstanding combination of easy processability and mechanical properties at both low and high temperatures makes the compositions and articles of the invention particularly suitable for applications wherein exposure to high temperature is requires such as, for example, piping for oil and gas extraction.

Should the disclosure of any patents, patent applications, and publications which are incorporated herein by reference conflict with the description of the present application to the extent that it may render a term unclear, the present description shall take precedence.

The invention will now be described in more details with reference to the following examples whose purpose is merely illustrative and not intended to limit the scope of the present invention.

### EXAMPLES

DSC

The Differential Scanning Calorimetry (DSC) measurements have been performed at a heating rate of 10° C./min according to ASTM D3418.

MFI: The melt flow index of the materials tested has been measured according to ASTM D-1238 standard under a piston load of 21.6 kg at 230° C.

Mechanical properties: The tensile tests (Elastic Modulus, Stress at yield and Strain at break) have been measured in MPa at 23° C. and 150° C. according to ASTM D638 type IV.

### Raw Materials:

Polymer component A: VDF polymer

Solef® 6015, a VDF homopolymer available from Solvay Specialty Polymers, having a MFI of 3-4 g/10 min (230° C./21.6 kg).

Polymer 1 is a VDF-HFP copolymer comprising 16% of HFP and having a MFI of 3-4 g/10 min (230° C./21.6 kg), available from Solvay Specialty Polymers.

Polymer component B:

Fluoropolyether F according to the following general formula:

HO—CH2CF2O—(CF2O)q(CF2CF2O)p—CF2CH2—OH

wherein:

TABLE 1
properties of Fluoropolyether used in examples

| | |
|---|---|
| Mn | 2000 |
| (molecular number in amu number average) | |
| Difunctional content (NMR, in %) | 94 |
| p/q ratio (NMR) | ~1 |
| Kinematic viscosity (cSt) | 85 |
| Density (20° C., in g/cm³) | 1.81 |
| Vapor pressure (100° C., in Torr) | 2 × 10⁻⁵ |
| Surface tension (20° C., in dyne/cm | 24 |

Polymer component C:

Melt processable perfluoropolymer T:
tetrafluoroethylene (TFE)/perfluoromethylvinylether (PVME) copolymer prepared as follows:
A 22 liters AISI 316 autoclave equipped with a stirrer working at 500 rpm was purged, and the following ingredients were introduced:
14.5 l of demineralized water
127 g of a microemulsion formed by:
   20% by weight of GALDEN® D₀₂, having the formula:

CF₃O—(CF₂CF(CF₃)O)ₘ(CF₂O)ₙ—CF₃
where m/n=20 and average molecular weight of 450;
30% by weight of a surfactant having the formula:

Cl—(C₃F₆O)—(CF₂CF(CF₃)O)ₘ₁—(CF(CF₃)O)_{q}—(CF₂O)ₙ₁—CF₂COO—NH₄_{⁺}
where n1 =1.0%m1, q=9.1%m1 and average molecular weight of 550;
   the remaining part being formed by H₂O.

The autoclave was put to vacuum and then heated to the reaction temperature of 75° C. Then ethane was charged as chain transfer agent with a delta pressure of 2.0 bar, perfluoromethylvinylether (PMVE) was charged with a delta pressure of 6.3 bar, and afterwards a TFE/PMVE mixture containing 13% by moles of MVE was fed to obtain the reaction pressure of 21 absolute Bar.

The polymerization was initiated by introducing 315 ml of a ammonium persulfate (APS) solution, obtained by dissolving 14.5 g APS in 1 liter of demineralized water.

The reaction pressure was kept constant by feeding the monomer mixture TFE/PMVE containing 13% by moles of PMVE. After 290 minutes of reaction, the polymerization was stopped, cooling the reactor to room temperature and releasing the residual pressure.

A latex containing 0.329% wt solids was discharged and coagulated with HNO₃, then the polymer was separated, washed with demineralized water and dried in an oven at 120° C. for about 16 hours.

The obtained polymer has a dynamic viscosity of 5 Pa×s at 280° C. and at a shear rate of 1 s⁻¹, a Tₘ₂ of 205.9° C., a ΔH_{2f}=6.279 J/g and is composed of 13% by moles of PMVE and 87% by moles of TFE.

### Plasticizer:

DBS: dibutylsebaccate of formula (C4H9—OOC—(CH2)8—COO—C4H9).

### Examples Preparation

### Example 1

A mixture of VDF polymers SOLEF® 6015 and Polymer 1 with a ratio 97/3 wt/wt was formed and mixed with 0.35 wt % of fluoropolyether F, 0.77 wt % of perfluoropolymer T and 2 wt % of DBS plasticizer (% by weight based on the total weight of the VDF polymers). The powders were mixed in a Henschel mixer and pelletized in a twin screw 30-34 extruder (LEISTRITZ), equipped with 6 temperature zones and a 4 mm-2 holes die.

The composition thus obtained in pellet form, was then melted and extruded to manufacture tapes of 2 mm thickness and width of 25 mm using a Brabender single screw extruder with a head of dimensions 25×5 mm. The temperature profile and the extrusion parameters are reported in the following table

TABLE 2
temperature extrusion profile for the
manufacture of the 2 mm thick tapes.

| | | |
|---|---|---|
| Zone 1 | ° C. | 190 |
| Zone 2 | ° C. | 200 |
| Zone 3 | ° C. | 200 |
| Zone 4 | ° C. | 210 |
| Zone 5 | ° C. | 210 |
| Zone 6 | ° C. | 215 |
| Torque | Nm | 47-49 |
| Pressure | bar | 42-44 |
| Melt temperature | ° C. | 208 |
| Output rate | Kg/h | 1.6 |
| Screw speed | rpm | 8 |

The extruded tapes have a smooth surface with no visible cracks and or surface defects.

### Example 2

Same composition and process of Example 1, except that DBS plasticizer is not present, and perfluoropolymer T is used at 1.2 wt %.

The extruded tapes have a smooth surface with no visible cracks and or surface defects.

### Example 3

Same composition and process of Example 2, except that the blend of SOLEF® 6015 and Polymer 1 is at a ratio of 92/8 wt/wt.

The extruded tapes have a smooth surface with no visible cracks or surface defects

### Example 4

Same composition and process of Example 2, except that instead of a blend, only SOLEF® 6015 homopolymer (100 wt %) is used.

The extruded tapes have a smooth surface with no visible cracks and or surface defects.

### Example 5 (comp.)

Same composition and process of Example 2, except that the blend of SOLEF® 6015 and Polymer 1 is at a ratio of 80/20 wt/wt. and 0.36 wt % of fluoropolyether F is added.

The extruded tapes have a smooth surface with no visible cracks and or surface defects.

### Testing of Examples 1-5

Mechanical properties were evaluated on specimen from the extruded bands and measured according to ASTM D638 at 23° C. and at 150° C. The data are given in table 3 below:

TABLE 3
Mechanical properties of Examples 1-5.

| | Elastic Modulus (MPa) | | Stress at yield (MPa) | | Strain at break (MPa) | |
|---|---|---|---|---|---|---|
| | 23° C. | 150° C. | 23° C. | 150° C. | 23° C. | 150° C. |
| Ex. 1 | 1000 | 107 | 30 | 4.6 | 51 | 20 |
| Ex. 2 | 1460 | 123 | 35 | 3.9 | 49 | 18 |
| Ex. 3 | 1460 | 108 | 35 | 3.8 | 52 | 19 |
| Ex. 4 | 1660 | 139 | 35 | 4.2 | 52 | 21 |
| Ex. 5c | 1060 | 86 | 31 | 2.8 | 47 | 14 |

The data concerning examples 1-5 clearly show how the samples according to the invention, while having similar stress at yield and strain at break values at 25° C. as the reference sample, they have unexpectedly a much higher value for these properties at 150° C. Elastic modulus appears generally higher than the reference across the board, and comparing Example 1 with Comp. Ex. 5 it can be noticed how in general, starting from materials having comparable Elastic modulus at 25° C., materials according to the invention surprisingly have an Elastic Modulus which is higher than expected at 150° C.

### Example 6

Polymer SOLEF® 6015 was mixed with 0.35 wt % of fluoropolyether F and 0.77 wt % of perfluoropolymer T (% by weight based on the total weight of the VDF polymers). The powders were mixed in a rotary blender and extruded in pellets as for examples 1-5.

### Example 7(c)

A composition in pellets as in example 6 was prepared wherein fluorpolyether F was absent and its amount replaced by an equal amount of perfluoropolymer T. In this composition Polymer SOLEF® 6015 was mixed with 1.12 wt % of perfluoropolymer T (% by weight based on the total weight of the VDF polymers).

### Testing of Samples 6 and 7(Comp)

16 g of the pellets of Example 6 and Example 7c were put in a micro compounder Xplore at 230° C. for 20 minutes to verify the processability of the two compositions at varying rpm. The measured force is an indication of the energy needed to melt compound the composition e.g. when extruding it, and is the average value of the forces registered during the last two minutes of the measurement. The data are given in Table 4 below:

TABLE 3

| | Force (N) at 230° C. | | |
|---|---|---|---|
| | 20 rpm | 40 rpm | 60 rpm |
| Ex. 6 | 2185 | 2935 | 3521 |
| Ex. 7c | 3710 | 4951 | 5791 |

The data of Table 4 show a clear decrease of the force when fluoropolyether F is used in combination with perfluoropolymer T in the compositions. Compositions according to the invention, comprising both one or more (per)fluoropolyether and one or more per(halo)fluoropolymers also have an advantage of being more easily processable using common extrusion conditions.

1. A thermoplastic polymeric composition comprising:
a) a vinylidene fluoride (VDF) based polymer component A,
b) a polymer component B, consisting of one or more (per)fluoropolyethers, in an amount of from 0.05 to 2% by weight based on the weight of polymer component A,
c) a polymer component C, consisting of one or more per(halo)fluoropolymers, in an amount of from 0.1 to 10% by weight based on the weight of polymer component A,
the composition being characterized in that said polymer component A consists of one or more vinylidene fluoride (VDF) homopolymers in an amount of 90-100% by weight of the polymer component A, and, optionally, of one or more VDF copolymers being present in an amount of 0-10% by weight of the polymer component A, said one or more VDF copolymers, when present, comprising 80-99% in moles of recurring units derived from VDF and 1-20% in moles of recurring units derived from a comonomer different from VDF.

2. The composition of claim 1 wherein the total amount of components A, B and C represents at least 80% of the total weight of the polymers contained in the composition.

3. The composition of claim 1 wherein said polymer component A has a melt flow index (MFI) of less than 20 g/10 min, and at least 0.01 g/10 min as measured according to ASTM D-1238 under a piston load of 21.6 Kg at 230° C.

4. The composition of claim 1 wherein said comonomer different from VDF is a fluorinated monomer.

5. The composition of claim 1 wherein said (per)fluoropolyether polymer component B consists of one or more (per)fluoropolyethers comprising recurring units selected from the group consisting of:
(I) —CFX—O—, wherein X is —F or —CF₃;
(II) —CF₂—CFX—O—, wherein X is —F or —CF₃;
(III) —CF₂—CF₂—CF₂—O —;
(IV) —CF₂—CF₂—CF₂—CF₂—O—;
(V) —(CF₂)ⱼ—CFZ—O— wherein j is an integer chosen from 0 and 1 and Z is a fluoropolyoxyalkene chain comprising from 1 to 10 recurring units chosen among the classes (I) to (IV);
and mixtures thereof.

6. The composition of claim 5 wherein said (per)fluoropolyether polymer component B comprises compounds complying with formula (I):
T₁—(CFX)ₚ—O—R_{f}—(CFX)_{p′}—T₂ (I)
wherein:
each of X is independently F or CF₃;
p and p′, equal or different each other, are integers from 0 to 3;
R_{f} is a fluoropolyoxyalkene chain comprising repeating units being selected from the group consisting of:
(i) —CFXO—, wherein X is F or CF₃,
(ii) —CF₂CFXO—, wherein X is F or CF₃,
(iii) —CF₂CF₂CF₂O—,
(iv) —CF₂CF₂CF₂CF₂O—,
(v) —(CF₂)ⱼ—CFZ—O— wherein j is an integer chosen from 0 and 1 and Z is a group of general formula —OR_{f′}T₃, wherein
R_{f′} is a fluoropolyoxyalkene chain comprising a number of repeating units from 0 to 10, said repeating units being chosen among the following:
—CFXO—, —CF₂CFXO—, —CF₂CF₂CF₂O—, —CF₂CF₂CF₂CF₂O—,
with each X being independently F or CF₃; and T₃ being C₁-C₃ perfluoroalkyl group, and mixtures thereof;
T₁ and T₂, are independently selected from the group consisting of
i) H,
ii) halogen atoms, and
iii) C₁-C₃₀ end-group optionally comprising heteroatoms chosen among O, S, N and/or halogen atoms.

7. The composition of claim 5 wherein said (per)fluoropolyether polymer component B comprises compounds selected from the group consisting of:
(a) HO—CH₂CF₂O(CF₂O)_{n′}(CF₂CF₂O)_{m′}CF₂CH₂—OH, m′ and n′ being integers, where the ratio m′/n′ ranges between 0.1 and 10;
(b) HO(CH₂CH₂O)ₙCH₂CF₂O(CF₂O)_{n′}(CF₂CF₂O)_{m′}CF₂CH₂(OCH₂CH₂)ₙOH, m′ and n′ being integers, where the ratio m′/n′ ranges between 0.1 and 10, and n ranges between 1 and 3;
(c) HCF₂O(CF₂O)_{n′}(CF₂CF₂O)_{m′}CF₂H, m′ and n′ being integers, where the ratio m′/n′ ranges between 0.1 and 10; and
(d) FCF₂O(CF₂O)_{n′}(CF₂CF₂O)_{m′}CF₂F, m′ and n′ being integers, where the ratio m′/n′ ranges between 0.1 and 10.

8. The composition of claim 7 wherein said (per)fluoropolyether polymer component B comprises compounds selected from the group consisting of:
(a) HO—CH₂CF₂O(CF₂O)_{n′}(CF₂CF₂O)_{m′}CF₂CH₂—OH, m′ and n′ being integers, where the ratio m′/n′ ranges between 0.1 and 10; and
(b) HO(CH₂CH₂O)ₙCH₂CF₂O(CF₂O)_{n′}(CF₂CF₂O)_{m′}CF₂CH₂(OCH₂CH₂)ₙOH, m′ and n′ being integers, where the ratio m′/n′ ranges between 0.1 and 10, and n ranges between 1 and 3.

9. The composition according to claim 1 wherein the weight average molecular mass of the one or more (per)fluoropolyethers making up said polymer component B is comprised between 400 and 100000.

10. The composition of claim 1 wherein said polymer component C comprises one or more per(halo)fluoropolymer selected from TFE copolymers comprising at least 2% wt, and at most 30% wt of recurring units derived from at least one fluorinated comonomer selected from the group consisting of:
(i) perfluoroalkylvinylethers complying with formula CF₂═CFOR_{f1′}, in which R_{f1′} is a C₁-C₆ perfluoroalkyl:
(ii) perfluoro-oxyalkylvinylethers complying with formula CF₂═CFOX₀, in which X₀ is a C₁-C₁₂ perfluorooxyalkyl having one or more ether groups;
(iii) C₃-C₈ perfluoroolefins.

11. The composition according to claim 10 wherein said one or more per(halo)fluoropolymer are selected from TFE/PMVE (tetrafluoroethylene/perfluoro-methylvinylether) copolymers consisting essentially of:
from 4 to 25% moles of recurring units derived from PMVE; and
from 96 to 75% moles of recurring units derived from TFE.

12. The composition of claim 1 wherein said composition also comprises one or more plasticizers selected from the group consisting of
dibutyl sebacate (DBS),
N-n-butylsulphonamide,
acetyl-tri-n-butylcitrate, and
polymeric polyesters derived from adipic, azelaic or sebacic acids and diols, having a molecular mass of at least 1500, and not exceeding 5000,
wherein said plasticizer is present in an amount between 1% and 20, by weight of the polymer component A.

13. A method for making a thermoplastic polymeric composition according to claim 1, said method comprising the steps of mixing polymer components A, B and C, optionally with one or more plasticizers and/or other optional ingredients and melt compounding said polymer components A, B and C and optional ingredients in a continuous or batch device.

14. An article comprising a thermoplastic polymeric composition according to claim 1, said article being selected from an injection molded article, an extrusion molded article, a machined article, a coated article, or a casted article.

15. An article according to claim 14 wherein said article is selected from the group consisting of coatings, films, membranes, shaped films, cable sheathing, pipes, flexible pipes, hollow bodies, fittings, and housings.

16. The composition of claim 1 wherein said polymer component A has a melt flow index (MFI) of less than 10 g/10 min, and at least 0.05 g/10 min as measured according to ASTM D-1238 under a piston load of 21.6 Kg at 230° C.

17. The composition of claim 4 wherein said comonomer different from VDF is a fluorinated monomer selected from the group consisting of vinylfluoride (VFl), chlorotrifluoroethylene (CTFE), hexafluoropropene (HFP), tetrafluoroethylene (TFE), trifluoroethylene (TrFE), (per)fluoroalkylvinylethers, perfluoroalkylethylenes, (per)fluorodioxoles, and mixtures thereof.

18. The composition of claim 1 wherein said (per)fluoropolyether polymer component B comprises compounds selected from:
(a) HO—CH₂CF₂O(CF₂O)_{n′}(CF₂CF₂O)_{m′}CF₂CH₂—OH, m′ and n′ being integers, where the ratio m′/n′ ranges between 0.2 and 5;
(b) HO(CH₂CH₂O)ₙCH₂CF₂O(CF₂O)_{n′}(CF₂CF₂O)_{m′}CF₂CH₂(OCH₂CH₂)ₙOH, m′ and n′ being integers, where the ratio m′/n′ ranges between 0.2 and 5, and n ranges between 1 and 3;
(c) HCF₂O(CF₂O)_{n′}(CF₂CF₂O)_{m′}CF₂H, m′ and n′ being integers, where the ratio m′/n′ ranges between 0.2 and 5; and
(d) FCF₂O(CF₂O)_{n′}(CF₂CF₂O)_{m′}CF₂F, m′ and n′ being integers, where the ratio m′/n′ ranges between 0.2 and 5.

19. The composition of claim 1 wherein said polymer component C comprises-one or more per(halo)fluoropolymer selected from TFE copolymers comprising at least 7% wt, and at most 20% wt of recurring units derived from at least one fluorinated comonomer selected from the group consisting of:
(iv) perfluoroalkylvinylethers complying with formula CF₂═CFOR_{f1′}, in which R_{f1′} is a C₁-C₆ perfluoroalkyl:
(v) perfluoro-oxyalkylvinylethers complying with formula CF₂═CFOX₀, in which X₀ is a C₁-C₁₂ perfluorooxyalkyl having one or more ether groups; and
(vi) C₃-C₈ perfluoroolefins.

20. The composition according to claim 10 wherein said one or more per(halo)fluoropolymer are selected from TFE/PMVE (tetrafluoroethylene/perfluoro-methylvinylether) copolymers consisting essentially of:
from 5 to 20% moles of recurring units derived from PMVE; and
from 95 to 80% moles of recurring units derived from TFE.
